(19) United States
(12) Patent Application Publication
(10) Pub. No.: US 2024/0224174 A1
(43) Pub. Date: Jul. 4, 2024

(54) METHOD AND APPARATUS FOR DYNAMICALLY DE-ACTIVATING SECONDARY CELL GROUP OF DUAL CONNECTIVITY

(71) Applicant: MEDIATEK INC., Hsin-Chu (TW)

(72) Inventors: Tsung-Ming Lee, Hsinchu City (TW); Chiao-Chih Chang, Hsinchu City (TW); Nien-En Wu, Hsinchu City (TW); Chih-Yuan Tsai, Hsinchu City (TW); Jun-Jie Su, Hsinchu City (TW)

(73) Assignee: MEDIATEK INC., Hsin-Chu (TW)

(21) Appl. No.: 18/090,517

(22) Filed: Dec. 29, 2022

(51) Int. Cl. H04W 52/02; H04W 24/10

(52) U.S. Cl. CPC H04W 52/0206; H04W 24/10

(57) ABSTRACT

A method for dynamically de-activating a secondary cell group (SCG) of dual connectivity includes: checking if at least one radio frequency (RF) band used by the SCG meets a pre-defined criterion, and in response to the at least one RF band meeting the pre-defined criterion, de-activating the SCG. For example, the at least one RF band is a 5G New Radio (NR) band.

### BACKGROUND

The present invention relates to wireless communications, and more particularly, to a method and apparatus for dynamically de-activating a secondary cell group of dual connectivity.

Multi-radio dual connectivity (MR-DC) is the technology that enables a 4G connection and a 5G connection to occur at the same time. In other words, MR-DC allows streams of 4G Long-Term Evolution (LTE) and 5G New Radio (NR) to flow simultaneously, which ultimately increases bandwidth and reduces service interruptions. In accordance with MR-DC, 4G LTE would become a master cell group (MCG) and 5G NR would become a secondary cell group (SCG). Frequency bands for 5G NR are separated into two different frequency ranges: Frequency Range 1 (FR1) and Frequency Range 2 (FR2). Regarding SCG, it may employ an FR1 low band (i.e. a 5G NR frequency band with a smaller band number), an FR1 high band (i.e. a 5G NR frequency band with a larger band number) or an FR2 band. The FR2 band has a large bandwidth (300 MHz or 600 MHz) but costs much power. Compared to the FR1 low band, the FR1 high band has a larger bandwidth. The larger bandwidth the frequency band has, the more power consumption the wireless communication apparatus has. The higher frequency the frequency band has, the more power consumption the wireless communication apparatus (e.g., user equipment) has. In addition, the narrower bandwidth and lower frequency band has larger coverage. For MR-DC, the SCG can be FR1 low band, FR1 high band or FR2 band. Thus, there is a need for an innovative dynamic band support switching scheme capable of dynamically de-activating the SCG to meet certain requirements.

### SUMMARY

One of the objectives of the claimed invention is to provide a method and apparatus for dynamically de-activating a secondary cell group of dual connectivity.

According to a first aspect of the present invention, an exemplary method for dynamically de-activating a secondary cell group (SCG) of dual connectivity is disclosed. The exemplary method includes: checking if at least one radio frequency (RF) band used by the SCG meets a pre-defined criterion; and in response to the at least one RF band meeting the pre-defined criterion, de-activating the SCG.

According to a second aspect of the present invention, an exemplary wireless communication apparatus is disclosed. The exemplary wireless communication apparatus includes a transceiver circuit and a control circuit. The transceiver circuit is arranged to transmit or receive wireless signals. The control circuit is coupled to the transceiver circuit, and arranged to check if at least one radio frequency (RF) band used by a secondary cell group (SCG) of dual connectivity meets a pre-defined criterion, and de-activate the SCG when the at least one RF band meets the pre-defined criterion.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication apparatus according to an embodiment of the present invention.

FIG. 2 is a flowchart illustrating a method for dynamically de-activating an SCG of dual connectivity (e.g., MR-DC) according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

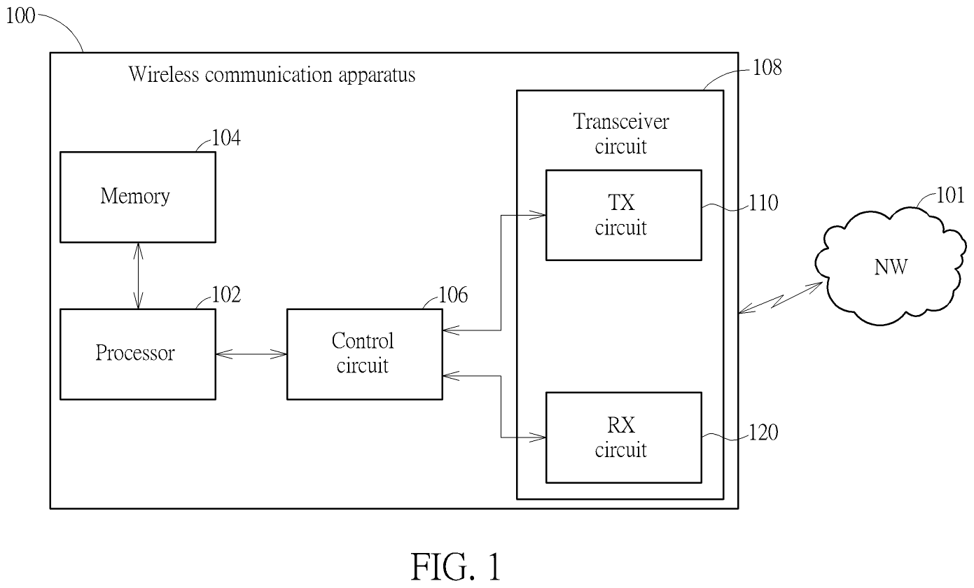

FIG. 1 is a diagram illustrating a wireless communication apparatus according to an embodiment of the present invention. The wireless communication apparatus 100 may be a portable electronic device, such as a Mobile Station (MS), which may be interchangeably referred to as User Equipment (UE). The wireless communication apparatus 100 includes a processor 102, a memory 104, a control circuit 106, and a transceiver circuit 108, where the transceiver circuit 108 acts as a network interface, and includes a transmitter (TX) circuit 110 and a receiver (RX) circuit 112. The transceiver circuit 108 is arranged to transmit wireless signals to and receive wireless signals from a network (NW) 101 via antenna(s), so as to communicate with the network 101 via a communication link established between the wireless communication apparatus 100 and the network 101. Specifically, the RX circuit 112 is arranged to receive wireless signals, and the TX circuit 110 is arranged to transmit wireless signals. The transceiver circuit 108 may be further arranged to perform radio frequency (RF) signal processing. For example, the RX circuit 112 may convert the received signals into intermediate frequency (IF) or baseband signals to be processed, and the TX circuit 110 may receive the IF or baseband signals from the control circuit 106 and convert the received signals into wireless signals to be transmitted to the network 101. For example, a network device is in the network 101, such as a wireless network or an access network (e.g., a terrestrial network (TN), a non-terrestrial network (NTN), a wireless local area network (WLAN), a personal area network (PAN) or a wireless local access network). According to an embodiment of the invention, the network device in the network 101 may be a cell, a Node-B (NB), an evolved Node-B (eNB), a g Node-B (gNB), a base station, a Mobility Management Entity (MME), an Access and Mobility Management Function (AMF) device, etc., at the network side, and communicates with the wireless communication apparatus 100 by the wireless signals via the communication link.

The memory 104 is arranged to store a program code. The processor 102 is arranged to load and execute the program code to manage the wireless communication apparatus 100. The control circuit 106 is arranged to control wireless communications with the network 101 (particularly, network device in network 101). For example, the control circuit 106 controls the TX circuit 110 of the transceiver circuit 108 to deal with downlink (DL) traffic between network 101 (particularly, network device in network 101) and wireless communication apparatus 100, and controls the RX circuit 112 of the transceiver circuit 108 to deal with uplink (UL) traffic between wireless communication apparatus 100 and network 101 (particularly, network device in network 101). The control circuit 106 can be realized by means of hardware, software, or a combination thereof. It should be noted that only the components pertinent to the present invention are illustrated in FIG. 1. In practice, the wireless communication apparatus 100 may include additional components to achieve other designated functions.

In this embodiment, the wireless communication apparatus 100 supports a dynamic band support switching feature for dynamically de-activating a secondary cell group (SCG) of dual connectivity (e.g., MR-DC). The control circuit 106 is arranged to check if at least one RF band used by the SCG of dual connectivity meets a pre-defined criterion, and de-activate the SCG when the at least one RF band meets the pre-defined criterion. For example, the at least one RF band is a 5G NR band or a frequency band supported by a later generation of wireless cellular technology. Further details of the proposed dynamic band support switching feature are described with reference to the accompanying drawings.

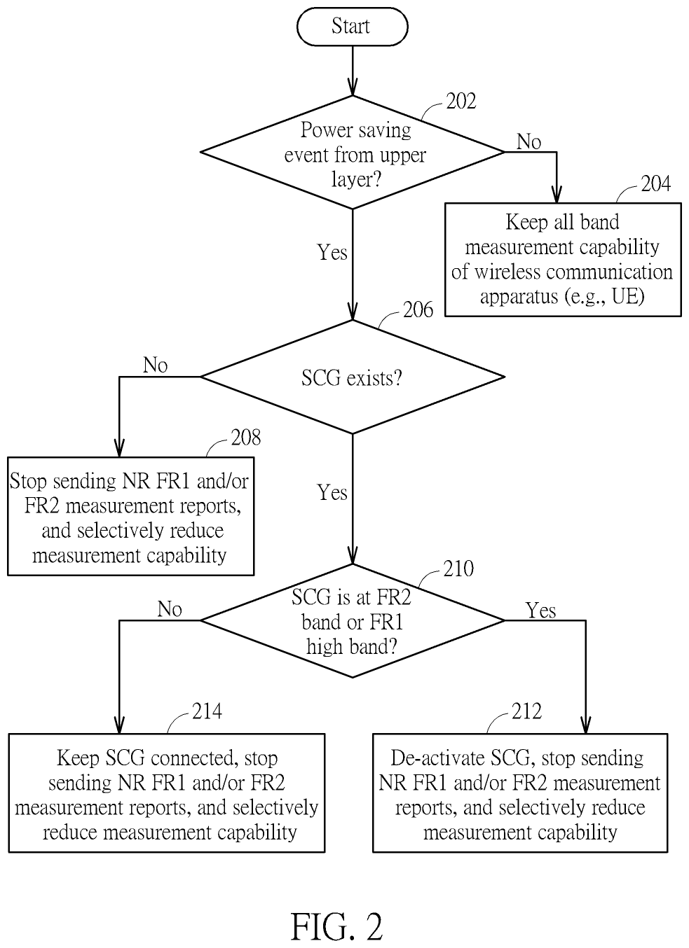

Please refer to FIG. 1 in conjunction with FIG. 2. FIG. 2 is a flowchart illustrating a method for dynamically de-activating an SCG of dual connectivity (e.g., MR-DC) according to an embodiment of the present invention. The method may be employed by the wireless communication apparatus 100 shown in FIG. 1. Specifically, the steps are performed under control of the control circuit 106. Provided that the result is substantially the same, the steps are not required to be executed in the exact order shown in FIG. 2. At step 202, the control circuit 106 checks if a power saving event is triggered by an upper layer detection that may be performed by the program code running on the processor 102. For example, the power saving event may be triggered due to low battery power and/or overheating. When the control circuit 106 does not receive the power saving event from the upper layer, the flow proceeds with step 204. At step 204, the control circuit 106 keeps all band measurement capability of the wireless communication apparatus (e.g., UE) 100. For example, the control circuit 106 performs NR measurements for FR1 low band, FR1 high band, and FR2 band.

When the control circuit 106 receives the power saving event from the upper layer, the flow proceeds with step 206. At step 206, the control circuit 106 checks if a connection between the wireless communication apparatus (e.g., UE) 100 and SCG provided by a network device (e.g., 5G base station) in the network 101 is established. When the SCG does not exist, the flow proceeds with step 208. At step 208, the control circuit 106 stops sending NR FR1 and/or FR2 measurement reports to the network 101 for saving power, and may selectively reduce the measurement capability. For example, the control circuit 106 may stop performing NR measurements for further power saving. For another example, the control circuit 106 may keep performing NR measurements to facilitate SCG connection that may be established later.

At step 210, the control circuit 106 checks if the SCG is at the FR2 band or FR1 high band. For example, the control circuit 106 checks a band number of the at least one RF band used by the SCG to determine if the SCG is at the FR2 band or FR1 high band. In some embodiments of the present invention, a 5G NR RF band with any of band numbers n1-n76 may be categorized as an FR1 low band, a 5G NR RF band with any of band numbers n77-n104 may be categorized as an FR1 high band, and a 5G NR RF band with any of band numbers n257-n263 may be categorized as an FR2 band. If the SCG is at the FR1 low band with a lower frequency and a smaller bandwidth, the flow proceeds with step 214. At step 214, the control circuit 106 keeps the SCG connected to the wireless communication apparatus (e.g., UE) 100. In addition, the control circuit 106 stops sending NR FR1 and/or FR2 measurement reports to the network 101 for saving power, and may selectively reduce the measurement capability. For example, the control circuit 106 may stop performing NR measurements for further power saving.

At step 212, the control circuit 106 de-activates the SCG by creating a fake measurement report indicating that current SCG cells' quality is bad, and performs an SCG failure information procedure specified in TS 38.331 5.7.3 to inform the network 101 of the fake measurement report, thereby preventing the network 101 from configuring secondary NR cells. In addition, the control circuit 106 stops sending NR FR1 and/or FR2 measurement reports to the network 101 for saving power, and may selectively reduce the measurement capability. For example, the control circuit 106 may stop performing NR measurements for further power saving. For another example, the control circuit 106 may keep performing NR measurements for measurement objects that are alive, thereby facilitating fast recovery of the SCG connection when the SCG connection is recovered later.

In this embodiment shown in FIG. 2, the control circuit 106 checks a band number of the at least one RF band used by the SCG to determine if de-activation of the SCG should be performed for saving power. However, this is for illustrative purposes only, and is not meant to be a limitation of the present invention. As mentioned above, the larger bandwidth the frequency band has, the more power consumption the wireless communication apparatus has; and the higher frequency the frequency band has, the more power consumption the wireless communication apparatus has. In a first alternative design, step 210 may be modified to check a frequency of the at least one RF band used by SCG to determine if de-activation of the SCG should be performed for saving power. Hence, when the frequency of the at least one RF band used by SCG is found higher than a pre-defined frequency threshold, the control circuit 106 de-activates the SCG by creating a fake measurement report indicating that current SCG cells' quality is bad, and performs an SCG failure information procedure specified in TS 38.331 5.7.3 to inform the network 101 of the fake measurement report, thereby preventing the network 101 from configuring secondary NR cells.

In a second alternative design, step 210 may be modified to check a bandwidth (e.g., initial bandwidth or dedicated bandwidth) of the at least one RF band used by SCG to determine if de-activation of the SCG should be performed for saving power. Hence, when the bandwidth (e.g., initial bandwidth or dedicated bandwidth) of the at least one RF band used by SCG is found larger than a pre-defined bandwidth threshold, the control circuit 106 de-activates the SCG by creating a fake measurement report indicating that current SCG cells' quality is bad, and performs an SCG failure information procedure specified in TS 38.331 5.7.3 to inform the network 101 of the fake measurement report, thereby preventing the network 101 from configuring secondary NR cells.

In a third alternative design, step 210 may be modified to check a frequency and a bandwidth (e.g., initial bandwidth or dedicated bandwidth) of the at least one RF band used by SCG to determine if de-activation of the SCG should be performed for saving power. Hence, when the frequency of the at least one RF band used by SCG is found higher than a pre-defined frequency threshold and the bandwidth (e.g., initial bandwidth or dedicated bandwidth) of the at least one RF band used by SCG is found larger than a pre-defined bandwidth threshold, the control circuit 106 de-activates the SCG by creating a fake measurement report indicating that current SCG cells' quality is bad, and performs an SCG failure information procedure specified in TS 38.331 5.7.3 to inform the network 101 of the fake measurement report, thereby preventing the network 101 from configuring secondary NR cells.

It should be noted that original UE capability for band support does not need to change. The dynamic band support switching scheme can dynamically de-active SCG of FR1 or FR2 when the at least one RF band used by SCG meets a pre-defined criterion, where the pre-defined criterion is based on a band number, a frequency, and/or a bandwidth. Furthermore, the same dynamic band support switching concept can be applied to other applications. For example, if the UE would like to save power, the FR2 band or FR1 high band SCG is de-activated in response to a power saving event triggered by the upper layer, and only the FR1 low band SCG addition is accepted. For another example, if the UE would like to gain higher throughputs, the FR1 low band SCG is de-activated in response to a high throughput event triggered by the upper layer, and only the FR2 band or FR1 high band SCG addition is accepted.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for dynamically de-activating a secondary cell group (SCG) of dual connectivity, comprising:
checking if at least one radio frequency (RF) band used by the SCG meets a pre-defined criterion; and
in response to the at least one RF band meeting the pre-defined criterion, de-activating the SCG.

2. The method of claim 1, wherein the at least one RF band is a 5G New Radio (NR) band.

3. The method of claim 1, wherein checking if the at least one RF band used by the SCG meets the pre-defined criterion comprises:
in response to receiving a power saving event, checking if the at least one RF band meets the pre-defined criterion.

4. The method of claim 1, wherein checking if the at least one RF band used by the SCG meets the pre-defined criterion comprises:
checking a band number of the at least one RF band.

5. The method of claim 1, wherein checking if the at least one RF band used by the SCG meets the pre-defined criterion comprises:
checking a frequency of the at least one RF band.

6. The method of claim 5, wherein checking if the at least one RF band used by the SCG meets the pre-defined criterion further comprises:
checking a bandwidth of the at least one RF band.

7. The method of claim 1, wherein checking if the at least one RF band used by the SCG meets the pre-defined criterion further comprises:
checking a bandwidth of the at least one RF band.

8. The method of claim 1, wherein de-activating the SCG comprises:
creating a fake measurement result; and
performing an SCG failure information procedure to inform a network of the fake measurement result.

9. The method of claim 1, further comprising:
in response to the at least one RF band meeting the pre-defined criterion, stopping sending measurement reports to a network.

10. The method of claim 9, further comprising:
in response to the at least one RF band meeting the pre-defined criterion, keeping performing measurements for measurement objects that are alive.

11. A wireless communication apparatus comprising:
a transceiver circuit, arranged to transmit and receive wireless signals; and
a control circuit, coupled to the transceiver circuit and arranged to:
check if at least one radio frequency (RF) band used by a secondary cell group (SCG) of dual connectivity meets a pre-defined criterion; and
de-activate the SCG when the at least one RF band meets the pre-defined criterion.

12. The wireless communication apparatus of claim 11, wherein the at least one RF band is a 5G New Radio (NR) band.

13. The wireless communication apparatus of claim 11, wherein the control circuit is arranged to check if the at least one RF band meets the pre-defined criterion when receiving a power saving event.

14. The wireless communication apparatus of claim 11, wherein the control circuit is arranged to check a band number of the at least one RF band, to determine if the at least one RF band meets the pre-defined criterion.

15. The wireless communication apparatus of claim 11, wherein the control circuit is arranged to check a frequency of the at least one RF band, to determine if the at least one RF band meets the pre-defined criterion.

16. The wireless communication apparatus of claim 15, wherein the control circuit is further arranged to check a frequency of the at least one RF band, to determine if the at least one RF band meets the pre-defined criterion.

17. The wireless communication apparatus of claim 11, wherein the control circuit is arranged to check a bandwidth of the at least one RF band, to determine if the at least one RF band meets the pre-defined criterion.

18. The wireless communication apparatus of claim 11, wherein the control circuit is arranged to de-activate the SCG by:
creating a fake measurement result; and
performing an SCG failure information procedure to inform a network of the fake measurement result.

19. The wireless communication apparatus of claim 11, wherein the control circuit is further arranged to stop sending measurement reports to a network, when the at least one RF band meets the pre-defined criterion.

20. The wireless communication apparatus of claim 19, wherein the control circuit is further arranged to keep performing measurements for measurement objects that are alive, when the at least one RF band meets the pre-defined criterion.
